(19) United States
(12) Patent Application Publication
(10) Pub. No.: US 2010/0183500 A1
(43) Pub. Date: Jul. 22, 2010

(54) Germane gas production from germanium byproducts or impure germanium compounds

(76) Inventor: Henry Lee, West Bloomfield, MI (US)

Correspondence Address: Kevin L. Bray, 230 Whims Court, Rochester, MI, 48306, US

(21) Appl. No.: 12/657,328

(22) Filed: Jan. 19, 2010

Related U.S. Application Data
(60) Provisional application No. 61/205,438, filed on Jan. 17, 2009.

(51) Int. Cl. C01B 6/06

(52) U.S. Cl. 423/645; 204/157.52

(57) ABSTRACT

A method for producing germane gas from a germanium-containing solid. The germanium-containing solid may be an oxidic or non-oxidic form of germanium and may further include silicon, metals, or other elements in combination with germanium. The process includes oxidizing the germanium-containing solid phase starting material, where the oxidation may be effected by contacting the germanium-containing solid phase starting material with an oxidizing solution. The oxidizing solution may be a basic solution comprising a hydroxide or an acidic solution. The oxidation product of the germanium-containing solid phase starting material is converted to germane through an electrochemical or chemical reduction process.

### RELATED APPLICATION INFORMATION

This application claims priority from U.S. Provisional Patent Application Ser. No. 61/205,438, entitled “Germanium Gas Production from Germanium Byproducts or Impure Germanium Compounds” and filed on Jan. 17, 2009, the disclosure of which is incorporated by reference in its entirety herein.

### FIELD OF INVENTION

This invention relates to the production of germane gas from germanium byproducts or impure germanium compounds. More particularly, this invention relates to the production of germane gas from germanium waste products generated in the gas or phase or plasma deposition of thin films containing germanium. Most particularly, this invention relates to the recovery of germane gas from germanium-containing solid phase byproducts formed in the production of solar cells that include a germanium or germanium alloy layer.

### BACKGROUND OF THE INVENTION

Concern over the depletion and environmental impact of fossil fuels has stimulated strong interest in the development of alternative energy sources. Significant investments in areas such as batteries, fuel cells, hydrogen production and storage, biomass, wind power, algae, and solar energy have been made as society seeks to develop new ways of creating and storing energy in an economically competitive and environmentally benign fashion. The ultimate objective is to minimize society's reliance on fossil fuels and to do so in an economically competitive way that minimizes greenhouse gas production.

Solar energy seeks to tap the unlimited supply of energy available from the sun. The general objective of solar energy is to convert electromagnetic energy emitted by the sun and received on earth into electrical energy. Maximization of the conversion efficiency is a central goal of solar energy and has motivated the search for more effective solar energy materials and systems. Most solar energy materials operate through the formation of electrical charge carriers (electrons and/or holes) upon absorption of incident electromagnetic radiation from the sun. In order to maximize conversion efficiency, it is desirable to have a solar energy material that absorbs as much of the solar spectrum as possible and that convert as much of the absorbed energy as possible to charge carriers while avoiding non-radiative (thermal) losses. It is also desirable to have a system that efficiently extracts the charge carriers from the solar energy material for delivery to an external load.

The field of solar energy is currently dominated by solar cells utilizing crystalline silicon as the active photovoltaic material. Crystalline silicon, however, has two main disadvantages as a solar energy material. First, preparation of crystalline silicon is normally accomplished through a seed-assisted Czochralski method. The method entails a high temperature melting process along with controlled cooling at near-equilibrium conditions and refining to produce a boule of crystalline silicon. Although high purity crystalline silicon can be achieved and the Czochralski method is amenable to n- and p-type doping, the method is inherently slow, expensive, and energy intensive.

Second, as an indirect gap material, crystalline silicon has a low absorption efficiency. Thick layers of crystalline silicon are needed to obtain enough absorption of incident sunlight to achieve reasonable solar conversion efficiencies. The thick layers add to the cost of crystalline silicon solar panels, lead to a significant increase in weight, necessitate bulky installation mounts, and make crystalline silicon solar panels rigid and unsuitable for applications requiring a flexible photovoltaic material.

Amorphous silicon has emerged as an attractive alternative to crystalline silicon. Amorphous silicon is a desirable solar material because it has a direct or quasi-direct bandgap and thus has a much higher absorption efficiency of the solar spectrum than crystalline silicon. The high absorption efficiency allows amorphous silicon to function as a solar energy material in thin film form. As a result, lightweight and efficient solar cells based on thin layers of amorphous silicon are possible.

Research with amorphous silicon has shown that higher efficiency solar cells are possible in multilayer (tandem or triple junction) solar cells. In the multilayer cell design, amorphous silicon is combined with one or more solar-responsive materials in a layered device structure. Each layer in the device structure is based on a distinct composition, where the different compositions differ in bandgap so that each layer optimizes the harvesting of a different portion of the solar spectrum. Because of its relative high energy bandgap, amorphous silicon is best suited for the absorption of the shorter wavelength portion of the solar spectrum. Longer wavelength solar radiation is not absorbed efficiently by amorphous silicon and experiences a low conversion efficiency in a solar cell made exclusively from amorphous silicon. By alloying amorphous silicon with other elements, it is possible to engineer the bandgap of the material and to optimize it for the collection of the longer wavelength portion of the solar spectrum.

Germanium is a preferred alloying element with silicon in amorphous and polycrystalline solar cells. Germanium forms a solid solution with silicon over the full range of compositions (Si₁₋ₓGeₓ, where x ranges from 0 to 1) and has the effect of reducing bandgap. A multilayer cell that includes a layer of amorphous (or polycrystalline) silicon and a layer of amorphous (or polycrystalline) silicon-germanium alloy increases absorption of the solar spectrum and improves solar efficiency.

One practical drawback of utilizing silicon-germanium alloys (or other germanium-containing layers) in solar cells is the relatively high cost of germanium. In order to achieve commercial scale production of silicon-germanium or other germanium-containing solar materials, it is necessary to employ a gas phase or plasma deposition process (e.g. CVD, PECVD). Silane (SiH₄) is widely used as the silicon precursor and the most common gas phase germanium source material is germane (Gen₄). A disadvantage associated with germane is its relatively high cost as a source material. The effective cost of germanium in a commercial process is further increased because of the poor utilization of germane in the gas or plasma phase deposition processes that currently prevail in the industry. In a typical process, only about 15% of the germanium supplied to the deposition process is incorporated in the deposited thin film of silicon-germanium or other germanium-containing material. The balance of the germanium is either vented as a waste gas stream (and scrubbed) or becomes incorporated in a solid waste product that forms from germanium, silicon, and other elements (e.g. dopants such as boron or phosphorous) or impurities (e.g. oxygen) that may be present in the process.

In order to improve the economic competitiveness of germanium-based solar materials, it is desirable to identify a low cost source of germanium or to increase the utilization of germane in current commercial processes.

### SUMMARY OF THE INVENTION

This invention provides a process for producing germane gas from germanium-containing solids. The process includes oxidizing germanium in the solid and converting the oxidized reaction product to germane gas through an electrochemical process or a reaction with a reducing agent.

The instant process provides an efficient route to germane gas from impure solid starting material, where the impure starting material includes germanium in combination with one or more other elements. In one embodiment, the germanium-containing solid includes germanium and silicon. In another embodiment, the germanium-containing solid includes germanium and a metal. In a further embodiment, the germanium-containing solid includes germanium and one or more of boron, phosphorous, arsenic, carbon, or hydrogen. The germanium-containing starting material optionally includes oxygen.

In one embodiment, oxidation of the germanium-containing solid occurs by immersing it in an oxidizing solution. The oxidizing solution may be a metal hydroxide solution. Representative metal hydroxide solutions include alkali metal hydroxides, alkaline earth hydroxides, and transition metal oxides. In another embodiment, the oxidation solution may be an acid or an acidic solution. Immersion of the germanium-containing solid in the oxidizing solution may cause dissolution of the solid to form a solution and/or formation of a slurry or suspension of the solid.

The oxidized form of the germanium-containing solid preferably includes germanium dioxide (GeO₂) and may be converted to germane gas through an electrochemical reduction process or through a chemical reaction with a reducing agent.

In an embodiment of the instant process the germanium-containing solid is a byproduct formed in a gas phase or plasma reaction of germane or other germanium containing gas. In one embodiment, a gas phase germanium precursor is reacted, alone or in combination with other precursors, to form a thin film material and the germanium in the unutilized fraction of the germanium precursor forms a solid from which germane gas can be recovered according to the principles of the instant invention.

### DETAILED DESCRIPTION OF THE ILLUSTRATED EMBODIMENTS

Although this invention will be described in terms of certain preferred embodiments, other embodiments that are apparent to those of ordinary skill in the art, including embodiments that do not provide all of the benefits and features set forth herein. Accordingly, the scope of the invention is defined only by reference to the appended claims.

The instant invention provides a process for producing germane gas from a variety of solid phase germanium starting materials. The prevailing commercial process for producing germane uses high purity germanium dioxide (GeO₂) as a starting material, where high purity germanium dioxide is prepared commercially from a fly ash or zinc ore processing method. Since these processes are expensive to operate, the germanium dioxide source material for the commercial production of germane is costly and the cost of germane gas is accordingly high as a result. By enlarging the range of potential germanium-containing starting materials (which include impure materials) for germane production, the instant invention provides an opportunity to greatly reduce the cost of germane gas.

The instant invention permits the formation of germane gas from any germanium-containing solid. The germanium-containing solid may be an oxide or non-oxide. The germanium-containing solid may include germanium in combination with one or more of silicon, boron, phosphorous, arsenic, transition metal, alkali metal, alkaline earth metal, post-transition metal, or halogen. The germanium-containing solid may be a crystalline, polycrystalline, or amorphous phase material and may be a single phase or multiple phase material.

In one embodiment, less than 90% of the germanium in the germanium-containing solid starting material is in the form of germanium dioxide. In second embodiment, less than 80% of the germanium in the germanium-containing solid starting material is in the form of germanium dioxide. In a third embodiment, less than 70% of the germanium in the germanium-containing solid starting material is in the form of germanium dioxide. In a fourth embodiment, less than 50% of the germanium in the germanium-containing solid starting material is in the form of germanium dioxide. In a fifth embodiment, the germanium-containing solid starting material includes germanium in the form of germanium dioxide and a non-oxide of germanium.

In one embodiment, the germanium-containing solid is formed as a byproduct of a thin film process that forms a germanium-containing material. The thin film process may be a chemical vapor deposition process (e.g. CVD, PECVD, MOCVD) or a plasma deposition process (e.g. PECVD, sputtering, reactive sputtering). In the thin film process, a gas phase germanium precursor is delivered to the deposition process and reacted or decomposed to deposit a germanium-containing thin film material on a substrate. In most thin film processes, the utilization of the germanium precursor is low and only a relative small fraction of the germanium available from the precursor gets incorporated in the deposited thin film material. The balance of the germanium is vented as a gas phase waste product or becomes incorporated in a solid phase byproduct. Such solid phase byproducts are within the scope of starting materials for producing germane gas in the context of the instant invention.

In one embodiment, the germanium-containing solid is formed as a byproduct of the reaction of silane (SiH₄) and germane (GeH₄). In this reaction, silane and germane are gas phase precursors that react to form a silicon-germanium alloy on a substrate. The utilization of germane is low and less than half of the germanium supplied with the germane precursor is incorporated in the silicon-germanium alloy. A substantial fraction of the germanium ends up in a solid phase byproduct that also includes silicon. The byproduct may also contain low levels of oxygen. If the silicon-germanium alloy formed in the process is formed as an intentionally-doped n-type or p-type material, the byproduct may also include doping elements such as boron, phosphorous, or arsenic.

In other germanium thin film deposition processes, the germanium precursor is an organometallic compound such as alkyl germanium compound (e.g. Ge(CH₃)₄, Ge(C₂H₅)₄) or a germanium amine compound (e.g. Ge(NH₃)₄). In these processes, the byproduct germanium-containing solid may also include nitrogen, carbon, and/or hydrogen.

In embodiments where the germanium-containing solid is formed as a byproduct of a gas phase reaction or decomposition involving a germanium precursor, the instant invention may further include recovery of the germanium precursor from the effluent of the process. As indicated hereinabove, a portion of the germanium precursor is typically vented as a waste gas and discharged from the process as an effluent. The effluent is typically a mixed gas stream that may include other unreacted gas phase precursors used in the process, gas-phase byproducts formed in the process, diluent gases, and/or air. The effluent gas may be captured and fractionated to recover unreacted gas phase germanium precursors or other germanium-containing gases. Recovery of germanium from both the effluent and solid phase byproducts improves the overall efficiency and economics of the process.

In the instant invention, the germanium-containing starting material is first oxidized to form an oxidation product that is subsequently converted to germane gas. In one embodiment, the oxidation process includes contacting the germanium-containing starting material with an oxidizing solution. The oxidizing solution may be a basic solution, where the base is a hydroxide compound. The hydroxide compound may be an alkali metal hydroxide (e.g. NaOH, KOH), alkaline earth hydroxide (e.g. Ca(OH)₂, Sr(OH)₂, Mg(OH)₂), or transition metal hydroxide (e.g. Ni(OH)₂, Cu(OH)₂). In another embodiment, the oxidizing solution includes an acid. The acid may be a strong acid such as hydrochloric acid, nitric acid or sulphuric acid. (Hydrochloric acid (HCl) can be used to convert germanium in the germanium-containing solid to germanium chloride (GeCl₄), which can then be hydrolyzed to an oxidic form of germanium (e.g. GeO₂) and used in accordance with the instant invention.) The oxidation product includes germanium in an oxidized state and preferably converts non-oxidic germanium in the germanium-containing solid into germanium dioxide or other oxide of germanium.

Germane gas is next produced from the oxidation product of the germanium-containing starting material. The production of germane from the oxidation product of the germanium-containing starting material may occur through an electrochemical reduction process (such as that described in “Method for Preparing High-Purity Germanium Hydride” by Vorotyntsev and published as International Publication Number WO 2005/005673, the disclosure of which is incorporated by reference herein) or through a chemical reaction of the oxidation product of the germanium-containing starting material with a reducing agent (such as the process described in U.S. Pat. No. 4,668,502 by Russotti, entitled “Method of Synthesis of Gaseous Germane”, the disclosure of which is incorporated by reference herein).

In a typical electrochemical process, germane is prepared from the germanium dioxide component of a solution or slurry of the oxidation product of the germanium-containing starting material of the instant process. The electrolysis may be performed in an aqueous alkaline solution or slurry of the oxidation product of the germanium-containing starting material. The electrochemical process may be performed in an electrochemical diaphragm cell using, for example, a nickel cathode.

In a typical chemical reduction process, the oxidation product of the germanium-containing solid is dissolved or suspended in an aqueous hydroxide base and reacted with a metal borohydride or metal aluminum hydride (e.g. NaBH₄, LiBH₄, LiAlH₄). The product of this reaction is acidified with a strong acid to form a gaseous product, which is then purified to form germane gas.

Those skilled in the art will appreciate that the methods and designs described above have additional applications and that the relevant applications are not limited to the illustrative examples described herein. The present invention may be embodied in other specific forms without departing from the essential characteristics or principles as described herein. The embodiments described above are to be considered in all respects as illustrative only and not restrictive in any manner upon the scope and practice of the invention. It is the following claims, including all equivalents, which define the true scope of the instant invention.

We claim:

1. A method for producing germane gas comprising oxidizing a germanium-containing solid.

2. The method of claim 1, wherein said oxidizing comprises contacting said germanium-containing solid with an oxidizing solution.

3. The method of claim 2, wherein said oxidizing solution comprises a base.

4. The method of claim 3, wherein said base is a hydroxide.

5. The method of claim 4, wherein said hydroxide comprises an alkali metal, an alkaline earth metal, or a transition metal.

6. The method of claim 2, wherein said oxidizing solution comprises an acid.

7. The method of claim 6, wherein said acid is HCl, HNO₃ or H₂SO₄.

8. The method of claim 1, further comprising electrochemically reducing said oxidation product of said germanium-containing solid, said electrochemical reduction forming said germane gas.

9. The method of claim 1, further comprising chemically reducing said oxidation product of said germanium-containing solid, said chemical reduction forming said germane gas.

10. The method of claim 9, wherein said chemical reduction comprises reacting said oxidation product of said germanium-containing solid with a metal borohydride.

11. The method of claim 10, wherein said metal borohydride comprises sodium borohydride.

12. The method of claim 9, wherein said chemical reduction comprises reacting said oxidation product of said germanium-containing solid with a metal aluminum hydride.

13. The method of claim 12, wherein said metal aluminum hydride comprises lithium aluminum hydride.

14. The method of claim 1, wherein less than 90% of the germanium in said germanium-containing solid is present in the form of germanium dioxide.

15. The method of claim 1, wherein less than 70% of the germanium in said germanium-containing solid is present in the form of germanium dioxide.

16. The method of claim 1, wherein less than 50% of the germanium in said germanium-containing solid is present in the form of germanium dioxide.

17. A method of forming germane gas comprising:
reacting or decomposing a gas phase germanium precursor to form a thin film germanium material, said reaction or decomposition further forming a solid phase byproduct, said byproduct comprising germanium; and
oxidizing said byproduct.

18. The method of claim 17, wherein said gas phase germanium precursor comprises germane.

19. The method of claim 17, wherein said gas phase germanium precursor comprises an organogermanium compound.

20. The method of claim 17, wherein said reaction or decomposition of said gas phase germanium precursor occurs in the presence of silane.

21. The method of claim 17, wherein said thin film germanium material comprises silicon.

22. The method of claim 20, wherein said byproduct further comprises silicon.

23. The method of claim 20, wherein said reaction or decomposition of said gas phase germanium precursor further occurs in the presence of an n-type or p-type dopant.

24. The method of claim 23, wherein said n-type or p-type dopant comprises phosphorous, boron, or arsenic.

25. The method of claim 24, wherein said byproduct further comprises phosphorous, boron, or arsenic.

26. The method of claim 17, wherein said reaction or decomposition further forms a gas-phase byproduct, said gas-phase byproduct comprising a germanium-containing gas, said method further including capturing said gas-phase byproduct and recovering said germanium-containing gas.
